(19) United States
(12) Patent Application Publication
(10) Pub. No.: US 2016/0289106 A1
(43) Pub. Date: Oct. 6, 2016

(54) EMULSION SYSTEMS AND METHODS FOR DELIVERY OF IN-SITU REMEDIATION AMENDMENTS

(71) Applicant: OnMaterials, LLC, Escondido, CA (US)

(72) Inventor: John O. Freim, III, Escondido, CA (US)

(73) Assignee: OnMaterials, LLC, Escondido, CA (US)

(21) Appl. No.: 15/078,181

(22) Filed: Mar. 23, 2016

Related U.S. Application Data
(60) Provisional application No. 62/265,504, filed on Dec. 10, 2015.
(60) Provisional application No. 62/142,678, filed on Apr. 3, 2015.

(51) Int. Cl. C02F 1/68; B09C 1/02; B09C 1/00; B09C 1/08

(52) U.S. Cl. CPC C02F 1/682; B09C 1/08; B09C 1/02; B09C 1/002; C02F 2103/06

(57) ABSTRACT

Compositions and methods are described to accomplish the in-situ remediation of contaminated groundwater and soil. Such compositions may comprise oil droplets, a water-miscible non-aqueous liquid phase, and one or more solid particulates. The oil droplets and the solid particulates are contained within the water-miscible non-aqueous liquid phase. The solid particulates may comprise one or more of zero valent iron, iron silicide, ferrosilicon, magnetite, particulate carbon, iron/carbon composites, calcium carbonate, and palladium. The solid particulates may comprise zero valent iron particles. The water-miscible non-aqueous liquid phase may be glycerol and the composition may be an oil-in-glycerol emulsion. Exemplary methods of preparing a groundwater remediation product comprise mixing oil droplets, a water-miscible non-aqueous liquid phase, and solid particulates contained in the water-miscible non-aqueous liquid phase to form a composition. The composition may be diluted with water in a mass ratio of 0 to 99% water such that the composition becomes an aqueous product suitable for applying to groundwater and soil.

### CROSS-REFERENCE TO RELATED APPLICATIONS

This application is a non-provisional of and claims priority to U.S. Patent Application Ser. No. 62/265,504, filed Dec. 10, 2015, and U.S. Patent Application Serial No. 62/142,678, filed Apr. 3, 2015, each of which is hereby incorporated by reference in its entirety.

### FIELD OF THE DISCLOSURE

The following disclosure relates to systems and methods to accomplish the in-situ remediation of contaminated soil and groundwater.

### BACKGROUND

In-situ remediation involves adding remediation amendments to contaminated soil and groundwater. The remediation amendments react with and eliminate the toxic groundwater contaminants directly in the sub-surface and/or modify the groundwater environment so that it is favorable for the biodegradation of groundwater contaminants. Common remediation amendments include fermentable organics (e.g., lactate, vegetable oil) that degrade to produce molecular hydrogen, electrochemical reductants (e.g., zero valent iron, iron silicide), pH modifiers (e.g., calcium carbonate, magnesium hydroxide), sorbents (carbon, charcoal), and catalysts (palladium). vOften, mixtures of the above provide the best environment for in-situ remediation. Effective in-situ remediation is accomplished by bringing the remediation amendments into contact with the contaminated soil or groundwater, usually by injecting the amendments into wells, or through hollow rods driven into the ground (direct push injection), or through soil mixing.

Hydrophilic vegetable oil-in-water emulsions (emulsified vegetable oil (EVO)) used in anaerobic bioremediation are known in the art. The emulsion is stabilized using surfactants with a hydrophile-liphophile balance (HLB) appropriate for oil-in-water emulsions. In these systems, the continuous water phase often contains water soluble organic compounds (e.g., lactate) that degrade quickly to provide molecular hydrogen that supports the metabolism of bacteria involved in anaerobic bioremediation. The vegetable oil degrades more slowly to provide a longer term source of molecular hydrogen. These products are diluted with water and then applied to contaminated groundwater (injected) to help accomplish anaerobic in-situ bioremediation.

Existing vegetable oil-in-water EVO systems do not contain solid remediation amendments (e.g., reductants, pH modifiers, and sorbents) that can alter the groundwater chemistry to best accomplish in-situ remediation. Adding solid remediation amendments to these emulsions will expand their ability to accomplish the in-situ remediation of contaminated soil and groundwater. A fundamental limitation of the hydrophilic water-in-oil emulsions is that water has a low viscosity and the denser solid particles (e.g., iron) settle rapidly within the continuous water phase. Particle settling can render an unstable emulsion and phase separation, which is exacerbated when faster settling, larger particle size products are employed.

Adding solid remediation amendments to vegetable oil-in-water systems is also complicated by the fact that many solid amendments react with water. For example, iron reacts with water to produce hydrogen gas and calcium carbonate reacts with water to produce carbon dioxide. Not only are waterborne solid remediation amendments prematurely consumed by these reactions but gas evolution can destabilize the emulsion and change physical properties including emulsion droplet size and viscosity.

Hydrophobic water-in-oil emulsions can also address contaminated soil and groundwater. An example is emulsified vegetable oil (EZVI) developed by NASA. This product is a water-in-oil emulsion consisting of a continuous phase of vegetable oil with embedded water droplets containing zero valent metal particles. The emulsion is stabilized using surfactants with a hydrophile-liphophile balance (HLB) appropriate for water-in-oil emulsions. The premise behind this product is that the groundwater contaminant (e.g., trichloroethylene, usually non-polar) is brought into contact with and partitioned into the continuous non-polar (vegetable oil) phase and then transported into the water droplets where the contaminant elimination occurs through reaction with the iron particles. In parallel, biodegradation of the vegetable oil supplies molecular hydrogen to support the metabolism of anaerobic bacteria that degrade groundwater contaminants. The viscous hydrophobic emulsion is injected into the ground or is applied using soil mixing or similar techniques.

A fundamental limitation of the hydrophobic water-in-oil emulsions (EZVI) is that many important remediation amendments react with water (e.g., iron) and are partially consumed between the time of manufacturing and the time when the product is applied to the contaminated soil or groundwater. This reaction prematurely lowers the reactive capacity of the remediation amendments and renders the remediation system less effective.

Another fundamental limitation of the hydrophobic water-in-oil emulsions is that the physical characteristics can change as the remediation amendments (e.g., iron) react with water. For example, the reaction of iron and water produces hydrogen gas. Gas evolution can destabilize emulsions and increase viscosity. These changes can adversely affect the physical characteristics after the emulsion is fabricated but before it is applied into the ground; a high viscosity makes the emulsion difficult to pump and uniformly apply into the contaminated soil or groundwater.

Accordingly, there is a need for soil and groundwater remediation systems that produce stable oil and non-aqueous liquid emulsions, both hydrophobic and hydrophilic, incorporating solid remediation amendments within the non-aqueous phase.

### SUMMARY

Disclosed embodiments alleviate these problems by providing systems and methods to accomplish the in-situ remediation of contaminated soil and groundwater wherein a hydrophilic emulsion is provided containing oil droplets embedded within a continuous non-aqueous, water-miscible liquid phase. In exemplary embodiments, particulate amendments used for soil and groundwater remediation are contained within the continuous non-aqueous, water-miscible liquid phase.

Unlike other hydrophilic emulsion systems used for in-situ remediation that contain a water phase, in exemplary embodiments the remediation amendments are present in a non-reactive medium such as glycerol. Using a non-reactive liquid medium prevents problems associated with the reaction of water with solid remediation amendments. Another advantage is that when compared to water in oil emulsions, larger particle size products can be incorporated into the more viscous continuous non-aqueous and water miscible phase.

An example of a hydrophilic emulsion involves adding zero valent iron particles to glycerol along with a polyethylene glycol thickener that increases viscosity and minimizes particle settling. In exemplary embodiments, this glycerol and iron mixture is added to vegetable oil containing a surfactant system with a hydrophile-liphophile balance (HLB) appropriate for making an oil-in-glycerol emulsion. The two liquid phases are mixed and agitated to produce the oil-in-glycerol emulsion with the solid remediation amendments contained within the glycerol phase.

Exemplary embodiments of a hydrophilic composition for use in groundwater remediation comprise oil droplets, a water-miscible non-aqueous liquid phase, and one or more solid particulates. The solid particulates are contained within the continuous water-miscible non-aqueous liquid phase. The solid particulates may comprise one or more of zero valent iron, iron silicide, ferrosilicon, magnetite, particulate carbon, iron/carbon composites, calcium carbonate, and palladium. In exemplary embodiments, the solid particulates comprise zero valent iron particles. In exemplary embodiments the oil phase is soybean oil. In exemplary embodiments, the water-miscible non-aqueous liquid phase is glycerol and the composition is an oil-in-glycerol emulsion.

In exemplary embodiments, the solid particulates are in the range of 1 to 70% by mass. The solid particulates may have a particle size in the range of about 0.1 to 1000 micrometers. In exemplary embodiments, the water-miscible non-aqueous liquid phase is in the range of 40 to 99% by volume. The composition may further comprise a surfactant. In exemplary embodiments, the surfactant is in the range of 0.1 to 10 mass percent of the oil mass. In exemplary embodiments, the water-miscible non-aqueous liquid phase is selected from a group of one or more of propylene glycol, polyethylene glycol, glycerin, ethanol, and ethyl lactate. The oil droplets may be selected from a group of one or more of methyl soyate. soybean oil, peanut oil, corn oil, canola oil, coconut oil, or fish oil.

Exemplary methods of preparing a groundwater remediation product comprise mixing oil, a water-miscible non-aqueous liquid phase, and solid particulates contained in the water-miscible non-aqueous phase liquid to form a composition. In exemplary embodiments, a thickener is added to the composition. In exemplary embodiments, the solid particulates comprise zero valent iron particles. Zero valent iron particles may be added to glycerol to form a glycerol and iron mixture. Then, a surfactant and oil mixture may be added to the glycerol and iron mixture to form an oil-in-glycerol emulsion. The composition is then diluted with water in a mass ratio of 0 to 99% water such that the composition becomes an aqueous product and the aqueous product applied to soil and/or groundwater.

In exemplary embodiments at the time of use, the emulsion is diluted with water, mixed with chemical dispersants to minimize particle agglomeration, and applied directly to contaminated groundwater using injection wells, hollow metal rods, gravity feed, or soil mixing. In the subsurface, the contaminated groundwater and soil is treated using one of more of the oil and the remediation amendments.

Exemplary methods of groundwater remediation comprise diluting a hydrophilic composition with water in a mass ratio of 0 to 99% water such that the composition becomes an aqueous product. The composition being diluted comprises oil droplets, a diluted water-miscible non-aqueous liquid phase, and one or more solid particulates including zero valent iron particles. The oil droplets and the solid particulates are contained within the diluted water-miscible non-aqueous liquid phase. The aqueous product is then applied to soil and/or groundwater. In exemplary embodiments, the applying step comprises injecting the composition through metal rods with perforations or through screened wells at pressures ranging from 0 to 1000 psi. In exemplary embodiments, the applying step comprises inserting the composition into the soil or groundwater by one or more of gravity feed and soil mixing.

Disclosed embodiments also include systems and methods to accomplish the in-situ remediation of contaminated groundwater wherein a hydrophobic emulsion is provided containing non-aqueous, water miscible liquid droplets embedded within a continuous nonpolar oil phase. In exemplary embodiments, particulate amendments used for groundwater remediation are contained within the non-aqueous, water miscible liquid droplets.

Unlike other hydrophobic emulsion systems used for in-situ remediation that contain a water droplet phase with solid remediation amendments, in exemplary embodiments the remediation amendments are present in a water-miscible liquid such as glycerol. In exemplary embodiments the composition is then applied to contaminated groundwater and soil using pressure injections or soil mixing. In the subsurface, the contaminated groundwater and soil is treated using one of more of the oil and the remediation amendments.

Exemplary embodiments of a hydrophobic composition for use in groundwater remediation comprise water miscible, non-aqueous phase droplets, a continuous oil phase, and one or more solid particulates. The non-aqueous phase droplets are contained within the continuous oil phase, and the solid particulates may be contained with the non-aqueous phase droplets. The solid particulates may comprise one or more of: zero valent iron, iron silicide, ferrosilicon, magnetite, particulate carbon, iron/carbon composites, calcium carbonate, and palladium.

In exemplary embodiments, the non-aqueous phase droplets are selected from a group of one or more of propylene glycol, polyethylene glycol, glycerol, ethanol, and ethyl lactate. The oil phase may be selected from a group of one or more of methyl soyate, soybean oil, peanut oil, corn oil, canola oil, coconut oil, or fish oil. In exemplary embodiments, the sum of solid particulates within the non-aqueous water miscible droplet phase is in the range of 1 to 65 percent by mass. The solid particulate remediation amendments may have a particle size in the range of about 0.1 to 1000 micrometers. The water miscible liquid droplet phase may be in the range of 5 to 60 percent by volume. The oil phase may be in the range of 40 to 95 percent by volume.

In exemplary embodiments, an emulsion is formed using a surfactant system selected from a group with a hydrophilic/lipophilic balance capable of producing a glycerol in oil emulsion. The surfactant may be in the range of 0.1 to 10 mass percent of the oil mass. One example of a hydrophobic emulsion involves adding zero valent iron particles to glycerol along with a polyethylene glycol thickener that increases viscosity and minimizes particle settling within the non-aqueous phase droplets. In exemplary embodiments, this glycerol and iron mixture is added to vegetable oil containing a surfactant system with a hydrophile-liphophile balance (HLB) appropriate for making a glycerol-in-oil emulsion. The mixture is then agitated to produce the glycerol/particulate droplets contained within the continuous oil phase.

Exemplary methods of preparing a groundwater remediation product comprise mixing water miscible, non-aqueous phase droplets, a continuous oil phase, and one or more solid particulates. The non-aqueous phase droplets are contained within the continuous oil phase, and the solid particulates may be contained with the non-aqueous phase droplets. In exemplary embodiments, a thickener is added to the composition. In exemplary embodiments, the solid particulates comprise zero valent iron particles. A surfactant may be added to the iron mixture to form a glycerol-in-oil emulsion.

In exemplary embodiments, the hydrophobic emulsion is then injected directly into contaminated soil and groundwater using injection wells, hollow metal rods, gravity feed, or soil mixing. In exemplary embodiments, applying the emulsion comprises injecting the composition through metal rods with perforations or through screened wells at pressures ranging from 0 to 1000 psi. In exemplary embodiments, applying the emulsion comprises inserting the composition into the soil or groundwater by one or more of: gravity feed and soil mixing. In the subsurface, the contaminated groundwater and soil is treated using one of more of the oil and the remediation amendments.

An object of the present disclosure is to provide a single, stable delivery system for delivering multiple in-situ remediation amendments to contaminated groundwater. Another object of the present disclosure is to provide a single, stable delivery system where the in-situ remediation amendments are contained in a non-aqueous water-miscible phase that exhibits limited reactivity with the water-sensitive remediation amendments.

Another object of the present disclosure is to provide a single, stable delivery system where the remediation amendments are contained within the continuous phase instead of within the droplets allowing for the incorporation of larger particle size amendments compared to what are used in water-in-oil emulsions.

Another object of the present disclosure is to produce a single, stable delivery system where the remediation amendments are contained in the non-aqueous liquid droplet phase within a continuous oil phase. The hydrophobic emulsion has an affinity for non-polar contaminants, similar to what is present in existing hydrophobic water in oil emulsions.

These and other features and advantages will be appreciated from review of the following detailed description, along with the accompanying figures in which like reference numbers refer to like parts throughout.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is an exemplary embodiment of a composition in accordance with the present disclosure; and

FIG. 2 is an exemplary embodiment of a composition in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

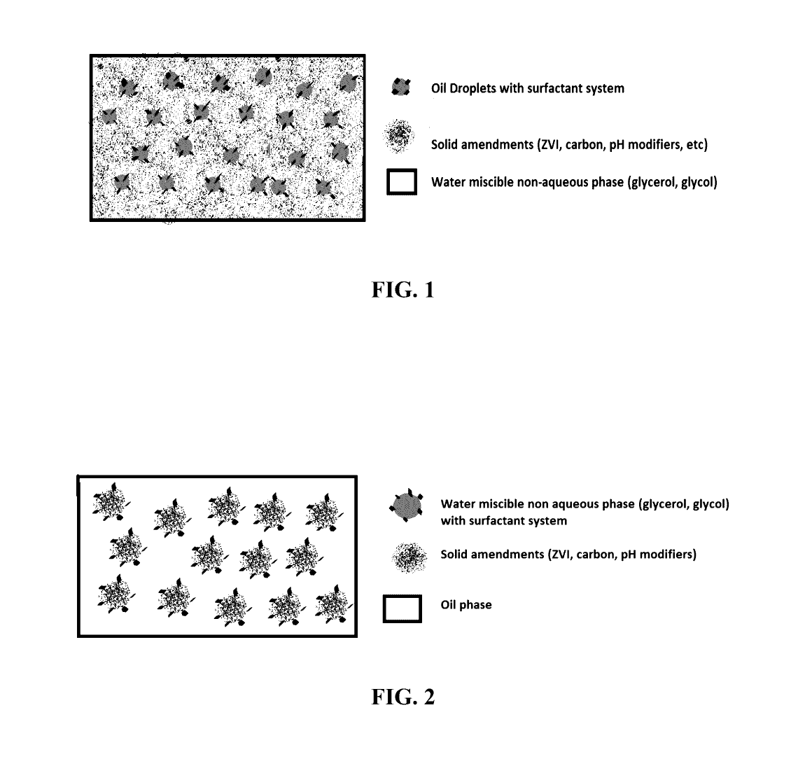

Referring to FIG. 1, exemplary embodiments involve fabricating compositions with oil droplets contained within a continuous water miscible phase such as glycerol to form emulsions. FIG. 1 shows an exemplary oil-in-water miscible phase liquid emulsion. In exemplary embodiments, it is an oil-in-glycerol emulsion. Remediation amendments are contained in the water-miscible liquid phase.

In exemplary embodiments, the oil-in-glycerol emulsion is formed by adding a mixture of:
1) A water insoluble oil phase that can include, but is not limited to, one of more of: methyl soyate, soybean oil, peanut oil, corn oil, canola oil, coconut oil, or fish oil.
2) A surfactant system with an HLB value capable of producing an oil-in-glycerol emulsion. This can include, but is not limited to, commercial products marketed under the trade names Span 20 (sorbitan monolaurate) and Tween 20 (polyoxyethylene (20) sorbitan monolaurate).
3) Instead of the combination of 1) and 2), use a commercially available composition formulated to make an oil in water emulsion for environmental remediation.
4) A non-aqueous, water miscible liquid that offers limited reactivity with solid remediation amendments. These can include, but are not limited to, propylene glycol, polyethylene glycol, glycerol, ethanol, and ethyl lactate and combinations thereof.
5) Thickeners, to increase the viscosity of the water miscible liquid phase. These can include, but are not limited to, polyethylene glycol, gums, and cellulose derivatives.
6) Thickeners, to increase the viscosity of the oil phase. These can include but are not limited to 12-hydroxysteararic acid and castor oil derivatives.
7) Remediation amendments that serve as electrochemical reductants. These can include, but are not limited to, zero valent iron, iron silicide, ferrosilicon, magnetite, and iron/carbon composites. These amendments can be added as dry powders or ground to a smaller particle size within the water-miscible phase using media mills. The remediation amendments are included in the water miscible liquid phase.
8) Remediation amendments that serve as pH modifiers. These can include, but are not limited to, calcium carbonate, magnesium hydroxide, and sodium bicarbonate. These amendments can be added as dry powders or ground to a smaller particle size within the water-miscible liquid phase.
9) Remediation amendments that serve as adsorbents. These can include, but are not limited to, activated carbon, charcoal, and activated carbon impregnated with iron. These amendments can be added as dry powders or ground to a smaller particle size within the water-miscible liquid phase.
10) Hydrogenation catalysts that increase the reaction rate with groundwater contaminants. These can include, but are not limited to, palladium deposited onto the surface of iron and palladium supported on aluminum oxide or other solid particles. These amendments can be added as dry powders or ground to a smaller particle size within the water miscible liquid phase.
11) The emulsion is formed by adding the oil/surfactant phase to the water miscible liquid containing the solid remediation amendments. The mixture is agitated using a shear homogenizer, colloid mill, high speed disperser, or any other suitable agitation device to produce the oil in non-aqueous liquid phase emulsion
12) The emulsion is diluted with water, mixed with chemical dispersants to minimize particle agglomeration, and applied directly to contaminated groundwater using injection wells, hollow metal rods, gravity feed, or soil mixing.

Exemplary embodiments involve adding zero valent iron powder, iron silicide powder, and carbon powder to one or more of propylene glycol, polyethylene glycol, glycerol, ethanol, ethyl lactate, and similar water-miscible liquids. A media mill can then be used to reduce the average particle size to below 5 micrometers. In exemplary embodiments, the total mass of the solid amendments is approximately 50% of the total mass of the non-aqueous liquid suspension, but the mass may be in a range of about 1% to about 70%. About 0.1 mass % to about 7 mass % of polyethylene glycol 8000 is then added to modify the viscosity of the mixture to minimize sedimentation of the solid amendments. In exemplary embodiments, about 1 mass % of polyethylene glycol 8000 is added. The mixture may then be agitated in a stirred media mill to reduce the size of the solid amendments and homogenize the mixture. The suspension is then removed from the media mill.

Another exemplary embodiment involves preparing an emulsion without milling or grinding the powders in the non-aqueous phase. In exemplary embodiments, the non-aqueous phase is prepared by mixing one or more of propylene glycol, polyethylene glycol, glycerol, ethanol, ethyl lactate, and similar water-miscible liquids. The solid amendments are then added, one or more of zero valent iron, iron silicide, ferrosilicon, magnetite, carbon, charcoal, carbon/iron composites, and calcium carbonate.

In exemplary embodiments, the total mass of the solid amendments is approximately 50% of the total mass of the non-aqueous liquid suspension, but the mass may be in a range of about 1% to about 70%. About 0.1 mass % to about 7 mass %, of polyethylene glycol 8000 is then added to modify the viscosity of the mixture to minimize sedimentation of the solid amendments. In exemplary embodiments, about 1 mass % of polyethylene glycol 8000 is added. The mixture may then be agitated using a colloid mill or disperser or other suitable agitation device to homogenize the material. The suspension is then removed from the colloid mill or homogenizer.

In exemplary embodiments, the oil phase is constituted of commercially available concentrated vegetable oil based products that are formulated to produce an oil-in-water emulsions used in environmental remediation. In exemplary embodiments, the oil phase is prepared by mixing one or more of soybean oil, methyl soyate, peanut oil, corn oil, canola oil, coconut oil, or fish oil. One or more thickeners may be added to increase the viscosity of the oil phase. These can include but are not limited to 12-hydroxystearate and other castor oil derivatives. Heating may be used to help dissolve the thickener in the oil phase. In exemplary environments the volume fraction of the thickeners is about 3 percent of the oil phase but may be in the range of about 0.1 percent to 10 percent.

One or more surfactants are then added with a hydrophile/lipophile balance (HLB) that promotes an oil in glycerol emulsion. These may include, but are not limited to, commercial products marketed under the trade names Span 20 (sorbitan monolaurate) and Tween 20 (polyoxyethylene (20) sorbitan monolaurate). In exemplary embodiments, the volume fraction of the oil phase is about 95 percent and the volume fraction of the surfactant phase is about 5 percent but these may be in the range 90 to 99 volume percent oil phase and 1 to 10 volume percent surfactant phase.

An exemplary hydrophilic oil in glycerol emulsion is produced by mixing the non-aqueous/particulate suspension with the oil/surfactant phase. The mixture may be agitated using a shear homogenizer, colloid mill, high speed disperser, or any other suitable agitation device to produce the oil in non-aqueous phase emulsion. In exemplary environments the volume fraction of the continuous non-aqueous liquid phase in the emulsion is about 50% and could be in the range of 30 to 99%. In exemplary embodiments the volume fraction of the oil droplet phase is about 50% and could be in the range of 1 to 70%.

Prior to injection into a contaminated soil or groundwater the mixture may be diluted with water to produce a lower viscosity oil in glycerol/water mixture. Chemical dispersants may be added to minimize inter particle agglomeration. The mixture may then be injected into the groundwater through screened wells, direct push injection through rods, gravity feed, or any other suitable injection mechanism. In exemplary environments the volume fraction of the emulsion phase is 5 volume percent and can be in the range of 0.1 to 99 volume percent with the balance water. Alternately, the emulsion described in the preceding paragraph may be injected into the groundwater without diluting in water and then injected into the groundwater through screened wells, using direct push injection through rods, or any other suitable injection mechanism.

Turning to FIG. 2, exemplary embodiments comprise compositions and methods of fabricating compositions with non-aqueous water miscible liquid droplets such as glycerol contained within a continuous oil phase such as vegetable oil. Solid remediation amendments are contained within the droplets of the non-aqueous water miscible liquid droplets. FIG. 2 shows a glycerol in oil phase emulsion in which the continuous oil phase is white and the water miscible glycerol droplets that contain the remediation amendments are grey. In exemplary embodiments, remediation amendments (e.g., zero valent iron, activated carbon, calcium carbonate) are contained within the non-aqueous water miscible droplets.

In exemplary embodiments, a hydrophobic emulsion with glycerol/particulate contained droplets within a continuous oil phase is formed by adding a mixture of:
1) A continuous hydrophobic phase that can include, but is not limited to, one of more of: soybean oil, methyl soyate, peanut oil, corn oil, canola oil, coconut oil, or fish oil.
2) A surfactant system with an HLB value capable of producing a glycerol-in-oil emulsion. This can include, but is not limited to, glycerol monostearate, stearyltrimethylammonium chloride, sodium stearate, trihydroxystearin, 12-hydroxystearic acid, castor oil derivatives, and combination thereof.
3) Thickeners to increase the viscosity of the continuous oil phase. The thickeners can include but are not limited to cellulose derivatives, trihydroxystearin, castor wax, and combinations thereof.
4) A non-aqueous water miscible liquid phase that offers limited reactivity with solid remediation amendments. These can include, but are not limited to, glycerol, propylene glycol, polyethylene glycol, ethanol, and ethyl lactate.
5) Thickeners to increase the viscosity of the water miscible droplet phase. The thickener can include, but are not limited to, polyethylene glycol, gums, and cellulose derivatives.
6) Remediation amendments that serve as electrochemical reductants. These can include, but are not limited to, zero valent iron, iron silicide, ferrosilicon, magnetite, and iron/carbon composites. These amendments can be added as dry powders or ground to a smaller particle size within the water miscible phase using grinding mills.
7) Remediation amendments that serve as pH modifiers. These can include, but are not limited to, calcium carbonate, magnesium hydroxide, and sodium bicarbonate. These amendments can be added as dry powders or ground to a smaller particle size within the water miscible phase.
8) Remediation amendments that serve as adsorbents. These can include, but are not limited to, activated carbon, activated charcoal, and activated carbon impregnated with iron. These amendments can be added as dry powders or ground to a smaller particle size within the water miscible phase.
9) Hydrogenation catalysts that increase the reaction rate with groundwater contaminants. These can include, but are not limited to, palladium deposited onto the surface of iron and palladium supported on aluminum oxide or other inert particles. These can be added as ground powders or ground to a smaller particle size within the water miscible phase.
10) The emulsion is formed by adding the oil/surfactant phase to the water miscible liquid containing the solid remediation amendments. The mixture is agitated using a shear homogenizer, colloid mill, high speed disperser, or any other suitable agitation device to produce the oil in non-aqueous liquid phase emulsion
11) The hydrophobic emulsion, and applied directly to contaminated groundwater using injection wells, hollow metal rods, or soil mixing.

In exemplary embodiments, the composition is prepared by combining the remediation amendments and thickeners to form a water miscible liquid phase. An oil phase is prepared by combining oils, thickeners, and surfactants. The hydrophobic emulsion is then produced by mixing the non-aqueous and oil phases followed by mechanical agitation. The emulsion may be injected into the contaminated soil and groundwater using screened wells, direct push injection through hollow rods, gravity feed, or any other suitable injection mechanism.

An exemplary embodiment involves preparing the non-aqueous liquid phase by mixing one or more of: propylene glycol, polyethylene glycol, glycerin, ethanol, ethyl lactate, and similar water miscible compounds. A thickener such as polyethylene glycol 8000 or cellulose may then be added to increase the viscosity and minimize sedimentation of the solid amendments. The solid amendments are then added. The solid amendments may be one or more of zero valent iron, iron silicide, ferrosilicon, magnetite, carbon, charcoal, carbon/iron composites, calcium carbonate, and a palladium hydrogenation catalyst.

In exemplary embodiments, the mixture is then added to a media mill such as an attritor mill or ball mill and agitated to reduce the particle size. In exemplary embodiments, the total mass of the solid amendments is approximately 50% of the total mass of the suspension, but the mass may be in a range of about 1% to about 70%. About 0.1 mass % to about 7 mass % of polyethylene glycol 8000 is then added to modify the viscosity of the mixture to minimize sedimentation of the solid amendments. In exemplary embodiments, about 1 mass % of polyethylene glycol 8000 is added. The mixture may then be agitated in a stirred media mill to reduce the size of the solid amendments and homogenize the mixture. The suspension may then be removed from the media mill.

Another exemplary embodiment involves preparing an emulsion without milling or grinding the powders in the non-aqueous phase. In exemplary embodiments, the non-aqueous phase is prepared by mixing one or more of propylene glycol, polyethylene glycol, glycerol, ethanol, ethyl lactate, and similar water miscible compounds. A thickener such as polyethylene glycol 8000 may be added to increase the viscosity and minimize sedimentation of the solid amendments. The solid amendments are then added, one or more of zero valent iron, iron silicide, ferrosilicon, magnetite, carbon, charcoal, carbon/iron composites, and calcium carbonate. About 0.1 mass % to about 7 mass %, of polyethylene glycol 8000 is then added to modify the viscosity of the mixture to minimize sedimentation of the solid amendments.

In exemplary embodiments, about 1 mass % of polyethylene glycol 8000 is added. The mixture may then be agitated using a colloid mill or disperser or other suitable agitation device to homogenize the material. In exemplary embodiments, the total mass of the solid amendments is approximately 50% of the total mass of the suspension, but the mass may be in a range of about 1% to about 70%. The mixture may then be agitated in a stirred media mill to reduce the size of the solid amendments and homogenize the mixture.

In exemplary embodiments, the oil phase is prepared by mixing one or more of, soybean oil, methyl soyate, peanut oil, corn oil, canola oil, coconut oil, or fish oil. Surfactants are then added with a hydrophile/lipophile balance (HLB) that promotes a forming a glycerol in oil emulsion. These surfactants may include, but are not limited to, glycerol monostearate, stearyltrimethylammonium chloride, sodium stearate, trihydroxystearin, 12-hydroxystearic acid, and combination thereof. The oil phase may be heated to promote dissolution of the surfactants.

In exemplary embodiments, the volume fraction of the oil phase is about 3 volume % but can range from 90 to 99 volume % oil and the volume 1 to 10 volume % surfactant. In exemplary embodiments, about 0.1 mass % to about 7 mass %, of trihydroxystearin is then added to modify the viscosity of the oil phase. In exemplary embodiments, about 1 mass % of trihydroxystearin is added.

In exemplary embodiments, a hydrophobic emulsion is formed by mixing the non-aqueous liquid/amendment phase with the oil phase. The mixture may be agitated using a shear homogenizer, colloid mill, high speed disperser, or any other suitable agitation device to produce the oil in non-aqueous phase emulsion. In exemplary environments the volume fraction of the continuous oil phase in the emulsion is about 50% and could be in the range of 30 to 99%. The volume fraction of the non-aqueous liquid droplet phase is about 50% and could be anywhere in the range of 1 to 60%. In exemplary embodiments, the hydrophobic emulsion is injected into soil and groundwater through screened wells, using direct push injection through rods, soil mixing or any other suitable injection mechanism.

Thus, it is seen that groundwater remediation compositions, systems and methods are provided. While the disclosed systems and methods have been described in terms of what are presently considered to be the most practical exemplary embodiments, it is to be understood that the disclosure need not be limited to the disclosed embodiments. It should be understood that any of the foregoing configurations and specialized components or chemical compounds may be interchangeably used with any of the systems of the preceding embodiments.

Although illustrative embodiments are described hereinabove, it will be evident to one skilled in the art that various changes and modifications may be made therein without departing from the disclosure. This disclosure is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A composition for use in groundwater remediation, comprising:
oil droplets;
a water-miscible non-aqueous liquid phase; and
one or more solid particulates;
wherein the oil droplets and the solid particulates are contained within the water-miscible non-aqueous liquid phase.

2. The composition of claim 1 wherein the solid particulates comprise one or more of: zero valent iron, iron silicide, ferrosilicon, magnetite, particulate carbon, iron/carbon composites, calcium carbonate, and palladium.

3. The composition of claim 1 wherein the water-miscible non-aqueous liquid phase is selected from a group of one or more of: propylene glycol, polyethylene glycol, glycerin, ethanol, and ethyl lactate.

4. The composition of claim 1 wherein the oil droplets are selected from a group of one or more of methyl soyate. soybean oil, peanut oil, corn oil, canola oil, coconut oil, or fish oil.

5. The composition of claim 1 wherein the solid particulates are in the range of 1 to 70% by mass of the non-aqueous liquid phase.

6. The composition of claim 1 wherein the solid particulates have a particle size in the range of about 0.1 to 1000 micrometers.

7. The composition of claim 1 wherein the water-miscible non-aqueous liquid phase is in the range of about 40 to 99% by volume.

8. The composition of claim 1 further comprising a surfactant.

9. The composition of claim 8 wherein the surfactant is in the range of 0.1 to 10 mass percent of the oil mass.

10. The composition of claim 1 wherein the solid particulates comprise zero valent iron particles.

11. The composition of claim 10 wherein the water-miscible non-aqueous liquid phase is glycerol and the composition is an oil-in-glycerol emulsion.

12. A method of preparing a groundwater remediation product comprising:
mixing oil droplets, a water-miscible non-aqueous liquid phase, and solid particulates contained in the water-miscible non-aqueous liquid phase to form a composition.

13. The method of claim 12 further comprising adding a thickener to the composition.

14. The method of claim 12 wherein the solid particulates comprise zero valent iron particles.

15. The method of claim 14 further comprising adding the zero valent iron particles to glycerol to form a glycerol and iron mixture.

16. The method of claim 15 further comprising adding a surfactant to the glycerol and iron mixture to form an oil-in-glycerol emulsion.

17. The method of claim 12 further comprising:
applying the composition into one or more of: soil and groundwater.

18. A method of groundwater remediation, comprising:
diluting a composition with water in a mass ratio of 0 to 99% water and adding a chemical dispersant such that the composition becomes an aqueous product, the composition comprising oil droplets, a water-miscible non-aqueous liquid phase, and one or more solid particulates including zero valent iron particles, the oil droplets and the solid particulates being contained within the water-miscible non-aqueous liquid phase; and
applying the aqueous product to one or more of: soil and groundwater.

19. The method of claim 18 wherein the applying step comprises injecting the aqueous product through metal rods with perforations or through screened wells at pressures ranging from 0 to 1000 psi.

20. The method of claim 18 wherein the applying step comprises inserting the aqueous product into the soil or groundwater by one or more of: gravity feed and soil mixing.
